(19) United States
(12) Patent Application Publication
(10) Pub. No.: US 2025/0131844 A1
(43) Pub. Date: Apr. 24, 2025

(54) METHOD AND SYSTEM FOR DETERMINING TREATMENT PROBLEM PROVIDED TO USER

(71) Applicant: MATA EDU, INC., Seoul (KR)

(72) Inventors: Tae Hyoung OH, Seoul (KR); Du Seop JUNG, Seongnam-si Gyeonggi-do (KR)

(73) Assignee: MATA EDU, INC., Seoul (KR)

(21) Appl. No.: 18/924,193

(22) Filed: Oct. 23, 2024

(30) Foreign Application Priority Data
Oct. 23, 2023 (KR) 10-2023-0142470

(51) Int. Cl. G09B 7/00

(52) U.S. Cl. CPC G09B 7/00

(57) ABSTRACT

A method for determining remedial problems provided to a user is provided. The method includes the steps of: determining, with reference to information on the user's understanding level for at least one concept, problems included in a remedial problem set for improving the user's understanding level; and updating the problems included in the remedial problem set in response to a change in the user's understanding level for the at least one concept.

### FIELD OF THE INVENTION

The present invention relates to a method and system for determining remedial problems provided to a user.

### BACKGROUND

With the advancement of computer-related technology, attempts have been made to apply various computer-related techniques to education-related fields.

In order to enhance the learning effectiveness of a user (e.g., elementary school student, middle school student, or high school student), intensive learning may be necessary for concepts in which the user is weak (e.g., concepts for which the user's understanding levels are low compared to other concepts).

According to traditional learning approaches, a user should solve multiple problems and personally search for other problems to learn about concepts which the user does not understand well (or for which the user has low understanding levels) based on the user's problem solving results. Further, if the user is not aware of what concepts the user is weak in, repetitive learning of such concepts cannot be carried out, resulting in a decrease in learning efficiency.

In this connection, the inventor(s) present a technique to enable efficient learning of concepts in which a user is weak by determining, with reference to information on the user's understanding level for at least one concept, problems included in a remedial problem set for improving the user's understanding level.

### PRIOR ART DOCUMENTS

### Patent Documents

(Patent Document 1) Korean Laid-Open Patent Publication No. 10-2022-0005365 (2022 Jan. 13)

### SUMMARY OF THE INVENTION

One object of the present invention is to solve all the above-described problems in the prior art.

Another object of the invention is to determine, with reference to information on a user's understanding level for at least one concept, problems included in a remedial problem set for improving the user's understanding level, and update the problems included in the remedial problem set in response to a change in the user's understanding level for the at least one concept.

Yet another object of the invention is to enable efficient learning of concepts in which a user is weak by determining problems included in a remedial problem set for improving the user's understanding level.

Still another object of the invention is to enable determination of remedial problems customized for a user by determining problems to be included in a remedial problem set according to the user's behavior or learning tendency.

The representative configurations of the invention to achieve the above objects are described below.

According to one aspect of the invention, there is provided a method comprising the steps of: determining, with reference to information on a user's understanding level for at least one concept, problems included in a remedial problem set for improving the user's understanding level; and updating the problems included in the remedial problem set in response to a change in the user's understanding level for the at least one concept.

According to another aspect of the invention, there is provided a system comprising: a problem determination unit configured to determine, with reference to information on a user's understanding level for at least one concept, problems included in a remedial problem set for improving the user's understanding level; and a problem update unit configured to update the problems included in the remedial problem set in response to a change in the user's understanding level for the at least one concept.

In addition, there are further provided other methods and systems to implement the invention, as well as non-transitory computer-readable recording media having stored thereon computer programs for executing the methods.

According to the invention, it is possible to determine, with reference to information on a user's understanding level for at least one concept, problems included in a remedial problem set for improving the user's understanding level, and update the problems included in the remedial problem set in response to a change in the user's understanding level for the at least one concept.

According to the invention, it is possible to enable efficient learning of concepts in which a user is weak by determining problems included in a remedial problem set for improving the user's understanding level.

According to the invention, it is possible to enable determination of remedial problems customized for a user by determining problems to be included in a remedial problem set according to the user's behavior or learning tendency.

### BRIEF DESCRIPTION OF THE DRAWINGS

FIG. 1 schematically shows the configuration of an entire system for determining remedial problems provided to a user according to one embodiment of the invention.

FIG. 2 specifically shows the internal configuration of remedial problem management system according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the Entire System

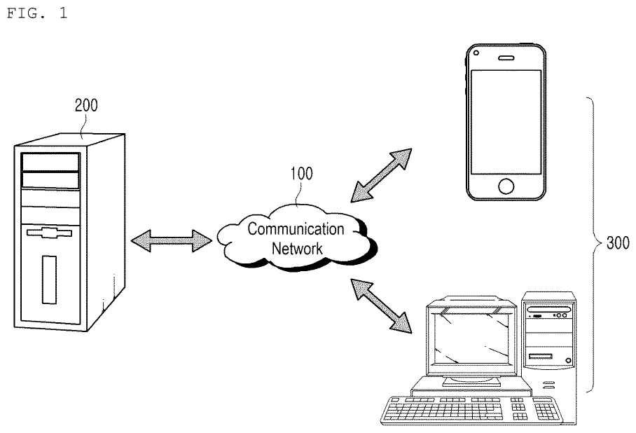

FIG. 1 schematically shows the configuration of the entire system for determining remedial problems provided to a user according to one embodiment of the invention.

As shown in FIG. 1, the entire system according to one embodiment of the invention may comprise a communication network 100, a remedial problem management system 200, and a device 300.

First, the communication network 100 according to one embodiment of the invention may be implemented regardless of communication modality such wired as and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the remedial problem management system 200 according to one embodiment of the invention may function to determine, with reference to information on a user's understanding level for at least one concept, problems included in a remedial problem set for improving the user's understanding level, and update the problems included in the remedial problem set in response to a change in the user's understanding level for the at least one concept.

The configuration and functions of the remedial problem management system 200 according to the invention will be discussed in more detail below.

Next, the device 300 according to one embodiment of the invention is digital equipment capable of connecting to and then communicating with the remedial problem management system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDA), a web pad, and a mobile phone, may be adopted as the device 300 according to the invention.

In particular, the device 300 may include an application (not shown) for assisting the user to be provided with the functions according to the invention from the remedial problem management system 200. The application may be downloaded from the remedial problem management system 200 or an external application distribution server (not shown). Meanwhile, the characteristics of the application may be generally similar to those of a problem determination unit 210, a problem update unit 220, an understanding level update unit 230, a communication unit 240, and a control unit 250 of the remedial problem management system 200 to be described below. Here, at least a part of the application may be replaced with a hardware device or a firmware device that may perform a substantially equal or equivalent function, as necessary.

### Configuration of the Remedial Problem Management System

Hereinafter, the internal configuration of the remedial problem management system 200 crucial for implementing the invention and the functions of the respective components thereof will be discussed.

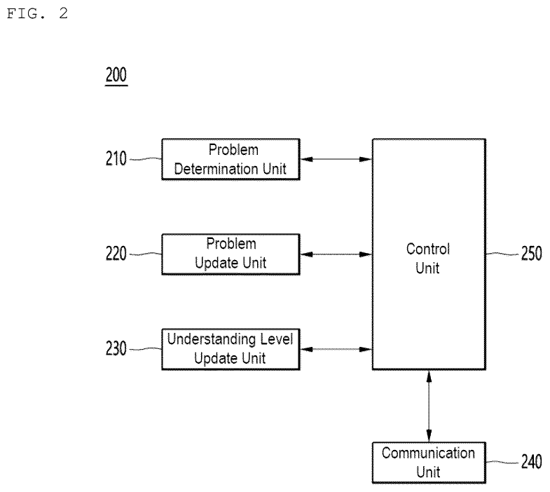

FIG. 2 specifically shows the internal configuration of the remedial problem management system 200 according to one embodiment of the invention.

As shown in FIG. 2, the remedial problem management system 200 according to one embodiment of the invention may comprise a problem determination unit 210, a problem update unit 220, an understanding level update unit 230, a communication unit 240, and a control unit 250. According to one embodiment of the invention, at least some of the problem determination unit 210, the problem update unit 220, the understanding level update unit 230, the communication unit 240, and the control unit 250 may be program modules to communicate with an external system (not shown). The program modules may be included in the remedial problem management system 200 in the form of operating systems, application program modules, and other program modules, while they may be physically stored in a variety of commonly known storage devices. Further, the program modules may also be stored in a remote storage device that may communicate with the remedial problem management system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the remedial problem management system 200 has been described as above, and it will be apparent to those skilled in the art that at least a part of the components or functions of the remedial problem management system 200 may be implemented in the device 300 or a server (not shown) or included in an external system (not shown), as necessary.

First, the problem determination unit 210 according to one embodiment of the invention may function to determine, with reference to information on a user's understanding level for at least one concept, problems included in a remedial problem set for improving the user's understanding level.

Specifically, at least one concept according to one embodiment of the invention may include a concept associated with a problem learned (or to be learned) by the user.

Further, the remedial problems according to one embodiment of the invention may include problems related to various subjects such as mathematics, science, Korean, and English.

Furthermore, the user's understanding level for the at least one concept according to one embodiment of the invention may be estimated (or determined) with reference to data on the user's problem solving results.

For example, a first user's understanding level for a first concept according to one embodiment of the invention may be estimated (or determined) with reference to a result of the user solving problems associated with the first concept. As a specific example, the first user's understanding level for the first concept according to one embodiment of the invention may be estimated (or determined) with reference to a ratio of correct answers given by the user in a result of the first user solving problems associated with the first concept.

As another example, the first user's understanding level for the first concept according to one embodiment of the invention may be estimated (or determined) with reference to a result of the first user solving problems associated with the first concept and results of other users (e.g., a second user) solving the problems. Therefore, according to one embodiment of the invention, a relative understanding level of the first user may be estimated with reference to not only the problem solving result of the first user but also the problem solving results of other users.

As another example, the first user's understanding level for the first concept according to one embodiment of the invention may be estimated by a concept understanding level estimation system (not shown). Here, the concept understanding level estimation system according to one embodiment of the invention may comprise a sequence data generation unit, an understanding level estimation unit, and a model assessment unit. Further, the concept understanding level estimation system according to one embodiment of the invention may function to generate concept-specific correctness/incorrectness sequence data with respect to at least one user, with reference to data on a result of the at least one user solving at least one problem associated with at least one concept, and estimate a first user's understanding level for a first concept using a concept-specific understanding level estimation model that is trained on the basis of the concept-specific correctness/incorrectness sequence data.

Here, the concept-specific understanding level estimation model according to one embodiment of the invention may be trained using a Bayesian knowledge tracing algorithm. Further, the concept-specific correctness/incorrectness sequence data according to one embodiment of the invention may include first sequence data generated at a first time point and second sequence data generated at a second time point that follows the first time point by a predetermined amount of time, and the concept-specific understanding level estimation model may be trained such that the concept-specific understanding level is estimated by assigning a greater weight to the second sequence data generated at the second time point than to the first sequence data generated at the first time point. Furthermore, the model assessment unit according to one embodiment of the invention may assess the concept-specific understanding level estimation model using a result of the estimation.

The concept t understanding level estimation system according to one embodiment of the invention will be described in detail below.

Further, the remedial problem set according to one embodiment of the invention may include at least one problem for improving the user's understanding level.

For example, the remedial problem set according to one embodiment of the invention may include at least one problem for improving the first user's understanding level for the first concept.

As another example, the remedial problem set according to one embodiment of the invention may include problems that are similar, at or above a predetermined level, to problems associated with the at least one concept and solved by the user in the past. As a specific example, the remedial problem set according to one embodiment of the invention may include problems that are similar, at or above a predetermined level, to problems associated with the at least one concept and incorrectly answered by the user in the past.

Therefore, according to the invention, the problems included in the remedial problem set may be determined such that the user may efficiently learn concepts in which the user is weak.

As another example, the remedial problem set according to one embodiment of the invention may include at least one problem for improving the user's understanding levels for two or more concepts.

Further, the problem determination unit 210 according to one embodiment of the invention may determine the problems included in the remedial problem set with further reference to a result of analyzing the user's behavior associated with learning using a behavior analysis model.

For example, the behavior analysis model according to one embodiment of the invention may include a machine learning model or an artificial intelligence model capable of deriving an analysis result in response to the user's behavior associated with learning.

Specifically, the problem determination unit 210 according to one embodiment of the invention may acquire time information on when the user accesses a learning system (not shown) and derive a of analyzing the user's concentration level (e.g., degree of focus) using the behavior analysis model. Here, the time information according to one embodiment of the invention may include at least one of information on a total length of time the user accesses the learning system and information on a frequency at which the user attempts to access the learning system.

As another example, the behavior analysis model according to one embodiment of the invention may be further in conjunction with a generative artificial trained intelligence model (e.g., ChatGPT).

As a specific example, the problem determination unit 210 according to one embodiment of the invention may use the behavior analysis model to analyze at least one of information on the user's attendance (e.g., information on a number of times the user was present, late, or absent) and information on the user's behavior associated with learning (e.g., information on learning attitudes recorded in student records) from at least one of a database associated with the remedial problem management system 200 (e.g., a database where student history information is stored, or a database related to student records) and an external system (e.g., the National Education Information System (NEIS) of the Office of Education).

Here, the problem determination unit 210 according to one embodiment of the invention may acquire information on the user's behavior associated with learning and use the behavior analysis model to derive an analysis result indicating that it is appropriate for the user to gradually improve his/her understanding level by learning a large number of similar types of remedial problems (e.g., the analysis result may be derived when the word “perseverance” or “diligence” is identified not less than a predetermined number of times in the user's student records), and may determine that a large number of problems whose types are similar to those of problems previously learned by the user (e.g., problems associated with concepts in which the user is weak due to failing to correctly answer the problems) are included in the remedial problem set. Conversely, the problem determination unit 210 according to one embodiment of the invention may acquire information on the user's behavior associated with learning and use the behavior analysis model to derive an analysis result indicating that the user improves his/her understanding level by learning a small number of problems similar to those previously learned, with a large understanding level increase per problem (e.g., the analysis result may be derived when the word “smart” or “quick” is identified not less than a predetermined number of times in the user's student records), and may determine that a small number of problems similar to those previously learned by the user are included in the remedial problem set.

However, the method of determining the problems included in the remedial problem set using the behavior analysis model according to the invention is not limited to those described above, but may be diversely changed as long as the objects of the invention may be achieved.

Further, the problem determination unit 210 according to one embodiment of the invention may determine the problems to be included in the remedial problem set with further reference to information on the user's learning tendency. Here, the learning tendency according to one embodiment of the invention may include at least one of two or more different learning tendencies.

For example, the learning tendency according to one embodiment of the invention may include at least one of a learning tendency indicating that the user gradually understands concepts by solving a large number of problems with a small understanding level increase per problem, and a learning tendency indicating that the user understands concepts by solving a small number of problems with a large understanding level increase per problem.

As another example, the information on the learning tendency according to one embodiment of the invention may be inputted by the user (or an administrator).

As another example, the information on the learning tendency according to one embodiment of the invention may be determined with reference to a result of analyzing the user's behavior associated with learning using the behavior analysis model.

As a specific example, when it is determined that the user has a learning tendency of gradually understanding concepts by solving a large number of problems with a small understanding level increase per problem, the problem determination unit 210 according to one embodiment of the invention may determine that a large number of problems determined to be relatively easy are included in the remedial problem set, thereby allowing the user to gradually understand the concepts. Meanwhile, when it is determined that the user has a learning tendency of understanding concepts by solving a small number of problems with a large understanding level increase per problem, the problem determination unit 210 according to one embodiment of the invention may determine that a small number of problems determined to be relatively difficult are included in the remedial problem set, thereby allowing the user's understanding level increase per problem to be enlarged.

Further, the problem determination unit 210 according to one embodiment of the invention may determine the problems included in the remedial problem set with reference to a problem solving result of at least one other user for the remedial problem set.

For example, when determining problems included in a remedial problem set for improving a first user's understanding level for a first concept, the problem determination unit 210 according to one embodiment of the invention may refer to a result of a second user solving a specific problem to determine whether to include the specific problem in the remedial problem set for the first user. As a specific example, when it is determined that the first user has a low understanding level for the first concept due to failing to correctly answer a first problem associated with the first concept, and that the second user has a low understanding level for the first concept due to failing to correctly answer a second problem associated with the first concept, the problem determination unit 210 according to one embodiment of the invention may determine that the second problem is included in the remedial problem set for the first user. Here, the problem determination unit 210 according to one embodiment of the invention may also determine that the first problem is included in a remedial problem set for the second user.

There may be cases where it is difficult to accurately estimate a difficulty level of a problem or an understanding level of a user using computer technology (e.g., technology related to artificial intelligence models). According to the invention, it is possible to determine whether to include a specific problem in a remedial problem set with reference to problem solving results of other users, thereby allowing a suitable remedial problem set to be determined.

Further, the problem determination unit 210 according to one embodiment of the invention may estimate a degree to which the user's understanding level for at least one concept corresponding to each of at least one candidate remedial problem set for improving the user's understanding level is improved, and determine a candidate remedial problem set estimated to improve the user's understanding level the most, among the at least one candidate remedial problem set, as the remedial problem set.

For example, the problem determination unit 210 according to one embodiment of the invention may determine at least one candidate remedial problem set for improving the user's understanding level. As a specific example, according to one embodiment of the invention, when the user has a low understanding level for a first concept, the problem determination unit 210 may determine a candidate remedial problem set that includes r problems among n problems associated with the first concept to improve the user's understanding level for the first concept (e.g., determine nCr candidate remedial problem sets).

As another example, the problem determination unit 210 according to one embodiment of the invention may estimate a degree to which the user's understanding level for at least one concept corresponding to each of at least one candidate remedial problem set is improved. As a specific example, the problem determination unit 210 according to one embodiment of the invention may calculate a probability that the first user correctly answers problems included in each of the at least one candidate remedial problem set, and estimate a degree to which the first user's understanding level for the first concept is improved by simulating a case when a specific candidate remedial problem set is solved, with reference to the probability. Here, when there are nCr candidate remedial problem sets, the problem determination unit 210 according to one embodiment of the invention may estimate a degree to which the user's understanding level for at least one concept is improved for each of the nCr candidate remedial problem sets.

Further, according to one embodiment of the invention, a probability that the first user correctly answers a specific problem may be calculated by a correctness/incorrectness prediction system (not shown). Here, the correctness/incorrectness prediction system according to one embodiment of the invention may function to acquire a set of data including a user variable determined on the basis of concept-specific correctness/incorrectness sequence data of at least one user, and at least one variable related to a problem and a concept associated with the user variable, and calculate a probability that a first user corresponding to a specific user variable correctly answers a first problem corresponding to a specific concept, with reference to the data set. The correctness/incorrectness prediction system according to the invention will be described in detail below.

As another example, the problem determination unit 210 according to one embodiment of the invention may determine a candidate remedial problem set estimated to improve the user's understanding level the most, among at least one candidate remedial problem set, as the remedial problem set. Here, according to one embodiment of the invention, since the remedial problem set may be determined with reference to a probability that the user correctly answers problems included in the candidate remedial problem set, the remedial problem set may not necessarily include only easy problems, and may be determined such that the user's understanding level is improved.

As another example, in the process of determining a remedial problem set for improving an understanding level for a first concept, the problem determination unit 210 according to one embodiment of the invention may determine a candidate remedial problem set that allows an understanding level for a second concept to be improved together. As a specific example, the problem determination unit 210 according to one embodiment of the invention may estimate a degree to which the user's understanding levels for a first concept and a second concept corresponding to each of at least one candidate remedial problem set are improved, with respect to each of the first and second concepts, and may determine a candidate remedial problem set that may improve the user's understanding levels for both the first concept and the second concept, among the at least one candidate remedial problem set, as the remedial problem set. Therefore, according to the invention, it is possible to determine a remedial problem set that may improve understanding levels for not only a single concept (e.g., the first concept) but also the second concept together.

As another example, in the process of estimating a degree to which the user's understanding level corresponding to each of at least one candidate remedial problem set is improved, the problem determination unit 210 according to one embodiment of the invention may improve the computational speed using Monte Carlo simulation. Here, the Monte Carlo simulation according to one embodiment of the invention may refer to a statistical technique that calculates the value of an objective function using randomly extracted random numbers.

As another example, the problem determination unit 210 according to one embodiment of the invention may determine a remedial problem set that may improve the user's understanding level for at least one concept the most using a candidate learning determination model.

However, the method of determining a remedial problem set from candidate remedial problem sets according to the invention is not limited to those described above, but may be diversely changed as long as the objects of the invention may be achieved.

Next, the problem update unit 220 according to one embodiment of the invention may function to update the problems included in the remedial problem set in response to a change in the user's understanding level for the at least one concept.

For example, the problem update unit 220 according to one embodiment of the invention may determine that the user's understanding level for a first concept is improved when a ratio of correct answers to at least one problem associated with the first concept changes to a predetermined ratio or above, with reference to a result of the user solving the at least one problem. Conversely, the problem update unit 220 may determine that the user's understanding level for the first concept is deteriorated when a ratio of correct answers to at least one problem associated with the first concept changes to a predetermined ratio or below.

As another example, the problem update unit 220 according to one embodiment of the invention may determine whether the user's understanding level is improved with reference to a result of the user solving a first problem associated with the first concept and a predicted correct answer rate for the first problem. As a specific example, according to one embodiment of the invention, when the user's predicted correct answer rate for the first problem is 80% and the user fails to answer the first problem correctly, the user's understanding level may be determined to be deteriorated. Conversely, according to one embodiment of the invention, when the user's predicted correct answer rate for the first problem is 40% and the user answers the first problem correctly, the user's understanding level may be determined to be improved.

However, the method of determining whether (or a degree to which) the user's understanding level has changed according to the invention is not limited to those described above, but may be diversely changed as long as the objects of the invention may be achieved.

Further, when the user's understanding level for the first concept reaches a predetermined level or above and is determined to be sufficient, the problem update unit 220 according to one embodiment of the invention may exclude problems associated with the first concept from the remedial problem set.

For example, when the remedial problem set according to one embodiment of the invention includes remedial problems associated with a first concept and remedial problems associated with a second concept, the problem update unit 220 may update the problems included in the remedial problem set such that only the remedial problems associated with the second concept are included in the remedial problem set by excluding the remedial problems associated with the first concept from the remedial problem set, in response to determining that the user's understanding level for the first concept is improved.

Next, the understanding level update unit 230 according to one embodiment of the invention may function to update the user's understanding level for the at least one concept with reference to the user's problem solving result for the remedial problem set.

For example, the understanding level update unit 230 according to one embodiment of the invention may update the user's understanding level for the remedial problem set from a first understanding level before learning to a second understanding level after the user's learning of the remedial problem set.

Further, the understanding level update unit 230 according to one embodiment of the invention may update the user's understanding level for the at least one concept with further reference to information on the user's predicted correct answer rate for the remedial problem set.

Specifically, the understanding level update unit 230 according to one embodiment of the invention may determine whether the user's understanding level is improved with reference to the user's problem solving result for the remedial problem set and the user's predicted correct answer rate for the remedial problem set. Here, the predicted correct answer rate for the remedial problem set according to one embodiment of the invention may be calculated by the correctness/incorrectness prediction system described above (or to be described below).

For example, according to one embodiment of the invention, when a predicted correct answer rate for a remedial problem set consisting of remedial problems associated with a first concept is lower than a predetermined level but a ratio of correct answers given by the user is high according to the user's problem solving result for the remedial problem set, the user's understanding level for the first concept may be updated as being improved. Conversely, according to one embodiment of the invention, when a predicted correct answer rate for the remedial problem set is higher than a predetermined level but a ratio of correct answers given by the user is low according to the user's problem solving result for the remedial problem set, the user's understanding level for the first concept may be updated as being deteriorated.

Next, the communication unit 240 according to one embodiment of the invention may function to enable data transmission/reception from/to the problem determination unit 210, the problem update unit 220, and the understanding level update unit 230.

Lastly, the control unit 250 according to one embodiment of the invention may function to control data flow among the problem determination unit 210, the problem update unit 220, the understanding level update unit 230, and the communication unit 240. That is, the control unit 250 according to one embodiment of the invention may control data flow into/out of the remedial problem management system 200 or data flow among the respective components of the remedial problem management system 200, such that the problem determination unit 210, the problem update unit 220, the understanding level update unit 230, and the communication unit 240 may carry out their particular functions, respectively.

Hereinafter, it will be described in detail how to estimate a user's understanding level for at least one concept according to one embodiment of the invention.

### Concept Understanding Level Estimation System

A concept understanding level estimation system (not shown) according to one embodiment of the invention may function to generate concept-specific correctness/incorrectness sequence data with respect to at least one user, with reference to data on a result of the at least one user solving at least one problem associated with at least one concept, and to estimate a first user's understanding level for a first concept using a concept-specific understanding level estimation model that is trained on the basis of the concept-specific correctness/incorrectness sequence data.

Further, the concept understanding level estimation system according to one embodiment of the invention may comprise a sequence data generation unit, an understanding level estimation unit, and a model assessment unit.

First, the sequence data generation unit according to one embodiment of the invention may generate concept-specific correctness/incorrectness sequence data with respect to at least one user, with reference to data on a result of the at least one user solving at least one problem associated with at least one concept.

According to one embodiment of the invention, the concept-specific correctness/incorrectness sequence data may be generated by preprocessing for performing concept-specific categorization with respect to the data on the result of solving the at least one problem associated with the at least one concept.

For example, according to one embodiment of the invention, the concept-specific correctness/incorrectness sequence data may be generated by preprocessing data on a result of solving problems to indicate correctness or incorrectness for each concept included in a problem solved in a time-series manner by each user. According to one embodiment of the invention, the concept-specific categorization for the at least one problem may be performed on the basis of concept-specific tagging made by an expert in the relevant field. Further, according to another embodiment of the invention, the concept-specific categorization for the at least one problem may be performed on the basis of a natural language processing (NLP) algorithm and a clustering algorithm.

Specifically, according to one embodiment of the invention, the concept-specific categorization for the at least one problem may be performed by tagging the at least one problem by concept with reference to a lookup table that is pre-created by the expert to categorize concepts (e.g., which may refer to a lookup table in which concepts are pre-categorized for each problem). Further, according to one embodiment of the invention, the concept-specific categorization for the at least one problem may be performed with reference to the lookup table using a NLP algorithm and a clustering algorithm.

Meanwhile, a concept-specific understanding level estimation model according to one embodiment of the invention may be trained on the basis of the concept-specific correctness/incorrectness sequence data.

For example, the concept-specific understanding level estimation model according to one embodiment of the invention may be trained using a Bayesian knowledge tracing algorithm. Herein, the Bayesian knowledge tracing algorithm may refer to an algorithm that probabilistically models a learner's cognitive processes during the course of learning to trace the learner's level of knowledge acquisition at a given time point.

According to one embodiment of the invention, the concept-specific understanding level estimation model may be trained with respect to a plurality of parameters (e.g., pre-existing knowledge, acquired knowledge, a guess, and a mistake) on the basis of the concept-specific correctness/incorrectness sequence data. According to one embodiment of the invention, the pre-existing knowledge indicates a probability that the user already possesses the knowledge, the acquired knowledge indicates a probability that the user fully understands the knowledge by solving a problem, the guess indicates a probability that the user guesses a correct answer to the problem without possessing the knowledge, and the mistake indicates a probability that the user possesses the knowledge but makes a mistake. Further, according to one embodiment of the invention, the plurality of parameters may be updated on the basis of an expectation maximization algorithm.

Meanwhile, according to one embodiment of the invention, the concept-specific understanding level estimation model may be trained such that the concept-specific understanding level is estimated by assigning a greater weight to second sequence data generated at a second time point (e.g., following a first time point by a predetermined amount of time) than to first sequence data generated at the first time point.

For example, according to one embodiment of the invention, the second sequence data may be assigned a greater weight than the first sequence data on the basis of a weighting function.

More specifically, the weighting function according to one embodiment of the invention may be expressed as Equation 1 below.

$${w}_{tl} = \frac{{d}^{t - l}}{{\sum }_{l = 1}^{t - 1} {d}^{t - 1}} ∈ ( 0 , 1 ] \qquad ( EQ . 1 )$$

Here, wₜₗ denotes a weight assigned to the l^{th} sequence data out of t pieces of sequence data, and d denotes a user-defined constant. For example, d may be set to 0.7. As another example, d may be set to a value that is observed to have the smallest error during the course of assessing the concept-specific understanding level estimation model by the model assessment unit to be described below.

This allows the concept-specific understanding level estimation model to more precisely estimate the user's understanding level by assigning a greater weight to more recent sequence data, reflecting the degree of forgetting a concept over time after solving a problem.

Further, the conventional Bayesian knowledge tracing algorithm is based on the assumption that a user does not forget knowledge once learned, and has a limitation that individual characteristics (e.g., difficulty) of problems cannot be considered.

According to one embodiment of the invention, the concept-specific understanding level estimation model may be trained with respect to the plurality of parameters with the weighted concept-specific reference to correctness/incorrectness sequence data, so that the user's understanding level may be more precisely identified compared to the conventional Bayesian knowledge tracing algorithm. Meanwhile, the concept-specific understanding level estimation model according to the invention is not necessarily limited to being trained by the above algorithm, and the training algorithm may be diversely changed as long as the objects of the invention may be achieved.

According to the invention, an understanding level estimation model may be built not only using the above concept-specific correctness/incorrectness sequence data, but also using concept-specific correctness/incorrectness sequence data of two or more users so that the model may be applied to the two or more users. Therefore, the understanding level estimation model may reflect learning experiences of multiple learners, thereby providing understanding level estimation results with high reliability and universality.

Next, the understanding level estimation unit according to one embodiment of the invention may estimate a first user's understanding level for a first concept using a concept-specific understanding level estimation model that is trained on the basis of the concept-specific correctness/incorrectness sequence data. Specifically, according embodiment of the invention, a user's understanding level for a concept (or concept understanding level) may refer to a probability that the user knows the concept at a given time point (e.g., at time t+1) on the basis of the concept-specific correctness/incorrectness sequence data (e.g., the data through time t).

Further, according to one embodiment of the invention, when a particular user has never solved a problem about a particular concept, the user's understanding level for the concept may be set to 0.5.

Meanwhile, according to one embodiment of the invention, the understanding level estimation unit may estimate the user's understanding level for a concept that the user has not encountered.

For example, according to one embodiment of the invention, the understanding level estimation unit may estimate a first user's understanding level for a second concept on the basis of a second user's understanding level for the second concept.

More specifically, according to one embodiment of the invention, the understanding level estimation unit may assess learning levels of the first user and the second user by comparing understanding levels of the first user and the second user for a plurality of concepts that the first user has already encountered. Next, the first user's understanding level for the second concept may be estimated on the basis of the assessed learning levels of the first and second users and the second user's concept correctness/incorrectness sequence data for the second concept.

As another example, according to one embodiment of the invention, the understanding level estimation unit may estimate the user's understanding level for a concept that the user has not encountered by assessing the similarity between the concept that the user has not encountered and a concept that the user has already solved.

For example, the understanding level estimation unit may apply a simulated annealing algorithm to a first problem containing a second concept not encountered by the user and a second problem containing a first concept encountered by the user, thereby assessing the similarity between the first and second concepts. According to one embodiment of the invention, on the basis of the assessed similarity between the concepts, the user's understanding level for the concept not encountered by the user may be estimated from the user's understanding level for the concept encountered by the user.

Meanwhile, according to one embodiment of the invention, the understanding level estimation unit may estimate the user's understanding level for a concept not encountered by the user on the basis of a collaborative filtering algorithm.

For example, the understanding level estimation unit may estimate the user's understanding level for the concept not encountered by the user, using a matrix factorization algorithm on the concept-specific correctness/incorrectness sequence data represented in a matrix structure with respect to a plurality of concepts (e.g., which may be a first concept encountered by the user and a second concept not encountered by the user) and results of a plurality of users solving problems. As another example, since the times at which the understanding levels are estimated for the plurality of users are different, the understanding level estimation unit may estimate the user's understanding level for the concept not encountered by the user using a temporal dynamics algorithm.

Next, according to one embodiment of the invention, the model assessment unit may assess the concept-specific understanding level estimation model using a result of estimating the user's understanding level.

For example, the model assessment unit according to one embodiment of the invention may assess the concept-specific understanding level estimation model on the basis of a k-fold cross validation algorithm. Specifically, the k-fold cross validation algorithm according to one embodiment of the invention refers to an algorithm for assessing the model by successively alternating training and validation steps, such that all the concept correctness/incorrectness sequence data is assessed. Meanwhile, the model assessment unit 230 according to the invention is not necessarily limited to assessing the model by the above algorithm, and the assessment algorithm for optimizing the model may be diversely changed as long as the objects of the invention may be achieved.

Hereinafter, it will be described in detail how to calculate a probability that a problem (or a remedial problem) is correctly answered according to one embodiment of the invention.

### Correctness/Incorrectness Prediction System

A correctness/incorrectness prediction system (not shown) according to one embodiment of the invention may function to acquire a set of data including a user variable determined on the basis of concept-specific correctness/incorrectness sequence data of at least one user, and at least one variable related to a problem and a concept associated with the user variable, and to calculate a probability that a first user corresponding to a specific user variable correctly answers a first problem corresponding to a specific concept, with reference to the data set.

Further, the correctness/incorrectness prediction system according to one embodiment of the invention may comprise a data acquisition unit and a probability calculation unit.

First, the data acquisition unit according to one embodiment of the invention may acquire a set of data including a user variable determined on the basis of concept-specific correctness/incorrectness sequence data of at least one user, and at least one variable related to a problem and a concept associated with the user variable.

According to one embodiment of the invention, the concept-specific correctness/incorrectness sequence data may be generated with reference to data on a result of at least one user solving at least one problem associated with at least one concept.

In addition, the user variable according to one embodiment of the invention refers to user identification information that allows a user to be identified, and may include a user ID. For example, the user ID may be expressed as a series of identification numbers (e.g., natural numbers) that may represent a user. Specifically, according to one embodiment of the invention, the natural identification numbers may be assigned in ascending order according to the order in which the user solves given problems.

Further, the problem-related variable according to one embodiment of the invention refers to problem identification information that allows a problem to be identified, and may include a problem identification number. For example, the problem identification number may be assigned to each problem on the basis of the sequence of curriculum units to be learned by the user.

Furthermore, the concept-related variable according to one embodiment of the invention refers to concept identification information that allows a concept to be identified, and may include a concept identification number and an understanding level. For example, the concept identification number may be assigned to each concept on the basis of the sequence of concepts to be learned by the user.

Specifically, the data acquisition unit according to one embodiment of the invention may acquire a data set in a matrix structure for the user variable determined on the basis of the concept-specific correctness/incorrectness sequence data, and the problem-related variable and concept-related variable associated with the user variable.

More specifically, with respect to a specific problem solved by a specific user, the matrix-structured data set according to one embodiment of the invention may be expressed as including data represented as 1s and 0s regarding whether the specific problem includes (or is associated with) a specific concept, an understanding level, and data represented as 1s and 0s regarding a result of solving the specific problem. In the data set according to one embodiment of the invention, a row may have a structure of [user ID, problem identification number, whether a concept is included, user's understanding level for each concept, and result of problem solving].

For example, it may be assumed that the user ID is 213, the problem identification number is 340, the number of concepts that may be applied to all problems is limited to 5, the concepts included in the problem are first and fifth concepts, and the user correctly answers the problem. Here, in the matrix-structured data set according to one embodiment of the invention, a row may be expressed as [213, 340, 1, 0, 0, 0, 0, 1, 0.6, 0.4, 0.3, 0.3, 0.65, 1].

Further, the user variable or the problem-related variable included in the data set according to one embodiment of the invention may be grouped on the basis of at least one piece of context information.

Specifically, according to one embodiment of the invention, the user variable may be specified into a user group on the basis of demographic information of users (e.g., age, gender, major, grade level, and residence), and the data acquisition unit may acquire the data set on the basis of the specified user group. For example, users with the same age, gender, major, and grade level may be categorized into a first user group. As another example, users may be categorized into a second user group in consideration of time spent solving problems, date of last access, and the like.

Further, according to one embodiment of the invention, the problem-related variable may be specified into a problem group on the basis of problem attribute information, and the data acquisition unit may acquire the data set on the basis of the specified problem group. The problem attribute information according to one embodiment of the invention refers to information indicating unique attributes of a problem, and may include information on a recommended grade level, a recommended major, scoring, a problem type (e.g., multiple choice or essay), presence or absence of an image, and the like.

Through the foregoing, it is possible to make a correctness/incorrectness prediction for a new user and a new problem as the user variable and the problem-related variable are grouped on the basis of context information, respectively.

Meanwhile, the structure of the data set according to the invention is not necessarily limited according to the above-described variables, and the variables and the structure of the data set may be diversely changed as long as the objects of the invention may be achieved.

Meanwhile, the concept-related variable included in the data set according to one embodiment of the invention may include the user's understanding level, which is estimated using a concept-specific understanding level estimation model trained on the basis of the concept-specific correctness/incorrectness sequence data. Here, the description of the concept-specific understanding level estimation model according to one embodiment of the invention is the same as those presented above in connection with the concept understanding level estimation system, and thus will be omitted.

Next, the probability calculation unit according to one embodiment of the invention may calculate a probability that a user corresponding to a specific user variable correctly answers a problem corresponding to a specific concept, with reference to the acquired data set.

For example, the probability according to one embodiment of the invention may refer to a conditional probability calculated using a binary classification algorithm. Specifically, the probability calculation unit according to one embodiment of the invention may train a binary classification model on the basis of the user variable, the problem-related variable, and the concept-related variable (e.g., the user's understanding level estimated using the concept-specific understanding level estimation model trained on the basis of the concept-specific correctness/incorrectness sequence data) included in the data set, and use the trained model to calculate a probability that the user correctly answers a specific problem. For example, the binary classification model may be a logistic regression model, a multi-layer perceptron (MLP), or a support vector machine (SVM).

More specifically, the probability calculation unit according to one embodiment of the invention may train a binary classification model through the data set in which the user variable and the problem-related variable are grouped on the basis of context information (e.g., demographic information and problem attribute information) to calculate a probability that a new user correctly answers a new problem using the trained model, without having to separately designate or specify a variable for the new user or the new problem.

Meanwhile, the binary classification model according to the invention is not necessarily limited to the above model, and may be diversely changed as long as the objects of the invention may be achieved.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks, and magnetic tapes; optical media such as compact disk-read only memory (CD-ROM) and digital versatile disks (DVDs); magneto-optical media such as floptical disks; and hardware devices such as read-only memory (ROM), random access memory (RAM), and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### DESCRIPTION OF THE REFERENCE NUMERALS

100: communication network
200: remedial problem management system
210: problem determination unit
220: problem update unit
230: understanding level update unit
240: communication unit
250: control unit
300: device

1. A method for determining remedial problems provided to a user, the method comprising the steps of:
determining, with reference to information on the user's understanding level for at least one concept, problems included in a remedial problem set for improving the user's understanding level; and
updating the problems included in the remedial problem set in response to a change in the user's understanding level for the at least one concept.

2. The method of claim 1, wherein in the problem update step, when the user's understanding level for a first concept reaches a predetermined level or above and is determined to be sufficient, problems associated with the first concept are excluded from the remedial problem set.

3. The method of claim 1, wherein in the determination step, the problems included in the remedial problem set are determined with further reference to a result of analyzing the user's behavior associated with learning using a behavior analysis model.

4. The method of claim 1, wherein in the determination step, the problems included in the remedial problem set are determined with further reference to information on the user's learning tendency, and
wherein the learning tendency includes at least one of two or more different learning tendencies.

5. The method of claim 1, wherein in the determination step, the problems included in the remedial problem set are determined with reference to a problem solving result of at least one other user for the remedial problem set.

6. The method of claim 1, wherein in the determination step, a degree to which the user's understanding level for the at least one concept corresponding to each of at least one candidate remedial problem set for improving the user's understanding level is improved is estimated, and a candidate remedial problem set estimated to improve the user's understanding level the most, among the at least one candidate remedial problem set, is determined as the remedial problem set.

7. The method of claim 1, further comprising the step of:
updating the user's understanding level for the at least one concept with reference to the user's problem solving result for the remedial problem set.

8. The method of claim 7, wherein in the understanding level update step, the user's understanding level for the at least one concept is updated with further reference to information on the user's predicted correct answer rate for the remedial problem set.

9. A non-transitory computer-readable recording medium having stored thereon a computer program for executing the method of claim 1.

10. A system for determining remedial problems provided to a user, the system comprising:
a problem determination unit configured to determine, with reference to information on the user's understanding level for at least one concept, problems included in a remedial problem set for improving the user's understanding level; and
a problem update unit configured to update the problems included in the remedial problem set in response to a change in the user's understanding level for the at least one concept.

11. The system of claim 10, wherein the problem update unit is configured to, when the user's understanding level for a first concept reaches a predetermined level or above and is determined to be sufficient, exclude problems associated with the first concept from the remedial problem set.

12. The system of claim 10, wherein the problem determination unit is configured to determine the problems included in the remedial problem set with further reference to a result of analyzing the user's behavior associated with learning using a behavior analysis model.

13. The system of claim 10, wherein the problem determination unit is configured to determine the problems included in the remedial problem set with further reference to information on the user's learning tendency, and
wherein the learning tendency includes at least one of two or more different learning tendencies.

14. The system of claim 10, wherein the problem determination unit is configured to determine the problems included in the remedial problem set with reference to a problem solving result of at least one other user for the remedial problem set.

15. The system of claim 10, wherein the problem determination unit is configured to estimate a degree to which the user's understanding level for the at least one concept corresponding to each of at least one candidate remedial problem set for improving the user's understanding level is improved, and to determine a candidate remedial problem set estimated to improve the user's understanding level the most, among the at least one candidate remedial problem set, as the remedial problem set.

16. The system of claim 10, further comprising:
an understanding level update unit configured to update the user's understanding level for the at least one concept with reference to the user's problem solving result for the remedial problem set.

17. The system of claim 16, wherein the understanding level update unit is configured to update the user's understanding level for the at least one concept with further reference to information on the user's predicted correct answer rate for the remedial problem set.
